(19) United States
(12) Patent Application Publication
(10) Pub. No.: US 2025/0243386 A1
(43) Pub. Date: Jul. 31, 2025

(54) FILLED POLYISOBUTENE-BASED PRESSURE SENSITIVE ADHESIVES AND METHODS FOR THEIR PREPARATION AND USE

(71) Applicant: Adhesives Research, Inc., Glen Rock, PA (US)

(72) Inventor: Tsukasa Mizuhara, Seven Valleys, PA (US)

(73) Assignee: Adhesives Research, Inc., Glen Rock, PA (US)

(21) Appl. No.: 18/856,231

(22) PCT Filed: Apr. 11, 2023
(86) PCT No.: PCT/US2023/018196

§ 371 Date: Oct. 11, 2024

Related U.S. Application Data
(60) Provisional application No. 63/330,232, filed on Apr. 12, 2022.

(51) Int. Cl. C09J 7/38; C09J 9/02; C09J 11/04

(52) U.S. Cl. CPC C09J 7/381; C09J 9/02; C09J 11/04; C09J 2301/302; C09J 2301/314; C09J 2301/408

(57) ABSTRACT

Filled polyisobutene-based (PIB) pressure sensitive adhesives (PSA) comprising a crosslinked structure therein. Compositions for preparing the PSAs comprise a PIB resin, a surface-treated and/or non-surface treated filler, wherein the surface treatment comprises a silane, a silazane or a combination thereof, and a SiH, SH or isocyanate functional crosslinking agent. Related embodiments include methods for preparing and using the filled PSAs, e.g., barrier adhesives and as a component of an adhesive tape.

### BACKGROUND OF THE INVENTION

The present invention generally relates to filled polyisobutene-based (PIB) pressure sensitive adhesives (PSA).

### BRIEF SUMMARY OF THE INVENTION

The present invention contemplates compositions for providing a filled PIB PSA having a crosslinked structure, as well as related methods for their preparation and use.

The inventive compositions comprise, consist essentially of, or consists of: a PIB resin; a non-surface-treated (NST) filler and/or a surface-treated (ST) filler wherein the surface treatment comprises, consists essentially of, or consists of a silane, a silazane or a combination thereof; a crosslinking agent comprising at least two moieties that will react with, at least, the ST filler and/or the NST filler; and, if required based on the particular crosslinking agent selected, a crosslinking catalyst and/or a catalytic inhibitor.

In one embodiment, the present invention contemplates a composition for providing a filled PIB PSA utilizing a SiH crosslinking agent. In this embodiment, the composition comprises, consists essentially of, or consists of: a PIB resin; a surface-treated (ST) filler wherein the surface treatment comprises, consists essentially of, or consists of a silane, a silazane or a combination thereof; a SiH functional crosslinking agent; a crosslinking catalyst; and a catalytic inhibitor. A related embodiment includes the filled PIB PSA provided after the crosslinking reaction is completed, methods of using these filled PIB PSAs, and methods for preparing the filled PIB PSAs. The methods for preparing the filled PIB PSAs comprise, consist essentially of, or consist of (a) providing a pre-reaction composition comprising, consisting essentially of, or consisting of: a PIB resin; a surface-treated filler wherein the surface treatment comprises, consists essentially of, or consists of a silane, a silazane or a combination thereof; and a SiH functional crosslinking agent, and, a catalytic inhibitor, and (b) adding a catalyst to the pre-reaction composition of a type and amount sufficient to initiate a crosslinking reaction between, at least, the silane, silazane or combination thereof on the surface-treated filler and the SiH functional crosslinking agent, thereby providing a filled PIB PSA.

In another embodiment, the present invention contemplates a composition for providing a filled PIB PSA utilizing a SH functional crosslinking agent. In this embodiment, the composition comprises, consists essentially of, or consists of: a PIB resin; a ST filler wherein the surface treatment comprises, consists essentially of, or consists of a silane, a silazane or a combination thereof; a SH functional crosslinking agent; and optionally, in certain embodiments wherein it is desired to use a radical initiator. A related embodiment includes the PIB PSA provided after the crosslinking reaction is completed, methods of using these filled PIB PSAs, and methods for preparing the filled PIB PSAs. The methods for preparing the filled PIB PSAs comprise, consist essentially of, or consist of (a) providing a pre-reaction composition comprising, consisting essentially of, or consisting of: a PIB resin; a ST filler wherein the surface treatment comprises, consists essentially of, or consists of a silane, a silazane or a combination thereof; a SH functional crosslinking agent; and, optionally, in certain embodiments, a radical initiator, and (b) exposing the pre-reaction composition to (i) heat or (ii) radiation in embodiments wherein an optional radical initiator is included, sufficient to initiate a crosslinking reaction between, at least, the silane, silazane or combination thereof on the ST filler and the SH functional crosslinking agent, thereby providing a filled PIB PSA.

In yet another embodiment, the present invention provides a composition for providing a filled PIB PSA utilizing an isocyanate crosslinking agent. In this embodiment, the composition comprises, consists essentially of, or consists of: a PIB resin; a filler comprising, consisting essentially of or consisting of (i) a NST silica and/or (ii) a ST silica or ST alumna, wherein the surface of the ST silica comprises a silane or a silazane; an isocyanate-functional crosslinking agent; and, optionally, in certain embodiments, a catalyst. A related embodiment includes the filled PIB PSA provided after the crosslinking is completed, methods of using these filled PIB PSAs, and methods for preparing the filled PIB PSA. The methods for preparing the filled PIB PSAs comprise, consist essentially of, or consist of (a) mixing a composition comprising, consisting essentially of, or consisting of: a PIB resin; a filler comprising, consisting essentially or consisting of (i) a NST silica and/or (ii) a ST silica or ST alumina, wherein the surface treatment of the silica comprises a silane or a silazane; and an isocyanate-functional crosslinking agent; and optionally, in certain embodiments, a catalyst, thereby providing a filled PIB PSA. Desirably, the filler in embodiments that include an isocyanate-functional crosslinking agent comprises, consists essentially of, or consists of ST silica, and more desirably a ST silica without a methacryloyl or an amino group.

The inventive PSAs provide at least one, and desirably a plurality, of advantages relative to existing PSAs. By way of illustration and not limitation, embodiments of the invention provide filled PIB PSAs, prepared using relatively low concentrations of a NST silica filler or ST filler exhibit improved static shear strength at higher temperatures relative to the same adhesive composition in the absence of crosslinking, relatively low creep (which may also be referred to as creep resistance), and in related embodiments also may provide the aforementioned improved static shear strength while also exhibiting at least one, and desirably a plurality of, additional beneficial properties including adhesion to polar surfaces (e.g., stainless steel and/or glass), tight liner release, water vapor transmission rate (WVTR) and, when acetylene black is used as an optional filler, desirable levels of electrical conductivity.

The inventive PSAs described herein may be used as, among other applications, a component in adhesive tapes or as barrier adhesives, the latter generally recognized as limiting water and oxygen transmission therethrough as well as providing a degree of insulation from electrical conductivity. Embodiments containing, at least, acetylene black, provide PSAs that possess conductive pathways through the adhesive, and may be used in applications requiring the aforesaid conductivity. Additional uses of the inventive PSAs will become apparent to those skilled in the art upon understanding the disclosure provided herein.

### DETAILED DESCRIPTION OF THE INVENTION

The various embodiments of the invention comprise at least one PIB resin. The PIB resins are, generally, resins having a PIB resin skeleton in the main or a side chain. In some embodiments, the PIB resins are substantially homopolymers of isobutylene.

PIB resins useful in certain embodiments also may be those that are devoid of any functional groups (e.g., reactive double bonds), those that include functional groups (e.g., PIBs comprising at least about 60 mol % terminal double bonds) or mixtures of these resins. It should be appreciated, however, that non-functionalized PIBs may have a very small concentration of reactive double bonds or other functional groups that are residual to their manufacture, typically less than about 5, 4, 3 or 2 mol %.

Illustrative of suitable commercially-available PIB resins that are non-functional include those in the OPPANOL® B and N Series (BASF), e.g., OPPANOL B10 (about 40,000 g/mol, viscosity average molecular weight (vMW)), B11 (about 47,000 vMW) B12 (about 55,000 vMW), B13 (about 65,000 vMW), B14 (about 73,000 vMW), B15 (about 85,000 vMW), N50 (about 425,000 vMW) N80 (about 800,000 vMW), N100 (about 1,100,000 vMW) and N150 (about 2,600,000 vMW), each of which may contain from about 1 to about 500 ppm of a stabilizer such as BHT. Illustrative of suitable commercially-available functional PIBs include those in the GLISSOPAL® Series (BASF), e.g., 1000, 1300, and 2300 and in the V-Series, e.g., V190, V230, V430, V500, V640, V700, V800, V950 and V1500.

In some embodiments, the PIB resins may comprise copolymers of isobutylene such as, for example, synthetic rubbers wherein isobutylene is copolymerized with another monomer. Synthetic rubbers include butyl rubbers which are copolymers of mostly isobutylene with a small amount of isoprene such as, for example, butyl rubbers. Illustrative of such suitable commercially-available synthetic rubbers include those available under tradenames VISTANEX® (Exxon Chemical Co.) and JSR BUTYL® (Japan Butyl Co., Ltd.).

The aforesaid synthetic rubbers also may include copolymers of mostly isobutylene with styrene, n-butene or butadiene. In some embodiments, a mixture of isobutylene homopolymer and butyl rubber may be used. Other useful copolymers include styrene-isobutylene diblock copolymer (SIB) and styrene-isobutylene-styrene triblock copolymer (SIBS), available under the tradename SIBSTAR® (Kaneka Corporation).

The PIB resins desirably may have a vMW ranging from about 40,000 to about 3,000,000 g/mol.

Desirably, and in some embodiments, two PIB resins having differing vMWs may be used, with these resins desirably being non-reactive. In these embodiments, the resins will comprise at least one relatively low vMW resin, and at least one relatively high vMW resin. Low vMW resins useful in the embodiments of the invention may have a vMW ranging from about 35,000 to about 100,000 g/mol, desirably from about 40,000 to about 75,000 g/mol, more desirably from about 45,000 to about 65,000 g/mol, and even more desirably from about 50,000 to about 60,000 g/mol. High vMW resins useful in the embodiments of the invention may have a vMW average ranging from about 300,000 to about 3,000,000 g/mol, desirably from about 400,000 to about 2,500,000 g/mol, more desirably from about 500,000 to about 2,000,000 g/mol, even more desirably from about 700,000 to about 1,500,000 g/mol. Preferably, the high vMW resins may have a vMW ranging from about 800,000 to about 1,300,000 g/mol, more preferably from about 900,000 to about 1,200,000 g/mol, and even more preferably from about 900,000 to about 1,100,000 g/mol.

Another resin desirably may be optionally included in certain embodiments of the invention. In embodiments including a SiH functional or SH functional crosslinking agent, this optional resin comprises at least two vinyl functional groups, and is desirably a PIB resin, e.g., a poly(acryl/methacryloyl) resin. It is believed that the vinyl groups in this optional resin are reactive with a crosslinking agent (as described herein), and as such will further assist in providing the desired crosslinked structure in the finished adhesive. When the embodiment includes an isocyanate-functional crosslinking agent, the optional resin may be a polyol, polyamine or polythiol resin that is reactive with the isocyanate functional crosslinking agent.

For example, and without intending to limit the scope of the invention, it was found that including this optional resin provided a positive effect on certain properties of the resulting PSA. More specifically, and in some embodiments (e.g., those including a SiH functional crosslinking agent), it was found that the inclusion of this resin assisted in providing an increase in static shear strength relative to adhesives prepared without this optional resin, thereby assisting in providing enhanced, and desirable, static shear strength.

In absolute amounts, this optional resin may be included in any suitable amount, such amount desirably ranging from about 0.1 wt. % to about 15 wt. %, more desirably from about 0.5 wt. % to about 10 wt. %, even more desirably from about 1 wt. % to about 7 wt. %, preferably from about 1 wt. % to about 5 wt. %, and more preferably from about 1 wt. % to about 3 wt. %, all weight percentages based on the total weight of the non-volatile components in the composition.

The inventive compositions useful in preparing the filled PIB PSAs may comprise, consist essentially of, or consist of a ST filler wherein the surface treatment comprises, consists essentially of, or consists of a silane, silazane or a combination thereof. The inclusion of a silane, silazane or combination thereof on the filler surface is believed to be important to the structure and performance of the resulting PSA, as they improve the hydrophobicity of fillers which, in turn, assist in providing relatively high moisture barrier properties (e.g., a low WVTR relative to PSAs prepared using NST silica), and in certain embodiments include functional groups that are believed to react with, at least, a crosslinking agent, thereby providing a desirable crosslinked structure within the PSA. The functional groups included in the silanes and silazanes may comprise alkylacryloyl groups, e.g., a methacryloyl group, amino groups, e.g., an aminopropylsilane. A ST filler which comprises a (non-functional) alkyl group, e.g., a dimethylsiloxane or a polydimethylsiloxane, will also provide a desirable crosslinked structure in the resulting PSA via, it is believed, a reaction of the SiOH groups on the ST filler with, at least, a crosslinking agent.

The ST fillers may comprise silicas and aluminas, and are desirably fumed, with the surface treatment preferably comprising, consisting essentially of, or consisting of an organosilane (which includes organohalosilanes and aminosilanes), an organosiloxane, an organosilazane or mixtures thereof, and in some embodiments, mixtures of an organosilane and an organzosilazane.

More preferably, an organosilane may be one or more of methacryloyloxypropyl-trialkoxysilane, aminopropylsilane, octylsilane (e.g., an octyltrialkoxysilane, such as octyltrimethoxysilane (OCTMO)), hexadecyltrialkoxysilane, dimethyldialkoxysilane, dimethyldichlorosilane and trimethylalkoxysilane, while an organosiloxane may be polydimethylsiloxane, and an organosilazane may be hexamethyldisilazane (HMDS). One combination of surface treatment useful in certain embodiments of the invention are fillers surface-treated with HMDS and an aminopropylsilane.

The ST fumed silicas and aluminas comprise a hydrophobic surface attributable at least in part to the aforedescribed surface treatment.

The ST fumed silicas have a BET specific surface area that may vary, but desirably range from about 80 to about 400 m²/gram, more desirably from about 100 to about 350 m²/gram, and even more desirably from about 125 to about 300 m²/gram. The ST fumed aluminas also may have a BET specific surface area that varies, but desirably ranges from about 50 to about 150 m²/gram, and more desirably from about 75 to about 110 m²/gram.

Illustrative of commercially-available ST silicas include, but are not limited to, AEROSIL® and CAB-O-SIL® ST fumed silicas, e.g., AEROSIL® R711, AEROSIL® R805, AEROSIL® R974 and AEROSIL® RA200HS (Evonik, Germany), while illustrative commercially-available ST aluminas include, but are not limited to, AEROXIDE® surface-treated fumed aluminas, e.g., AEROXIDE® Alu C 805 (Evonik, Germany). Generally, the “R” series AEROSIL® and CAB-O-SIL® ST fumed silicas do not include methacryloyl or amino groups, with the exception of R711 which includes a methacryloyl group and RA200HS which includes an amino group.

Certain embodiments of the invention may comprise NST silicas and/or NST aluminas, desirably as the sole filler. These silicas and/or aluminas, which are preferably fumed, are well-known to those skilled in the art, and are further generally considered in the relevant art to be hydrophilic. Such fumed silicas may have a BET specific surface area ranging from about 50 to about 400 m²/gram, and more desirably from about 150 to about 300 m²/gram. Illustrative of commercially-available NST fumed silicas include, but are not limited to, hydrophilic silicas marketed under the AEROSIL® trademarks (Evonik, Germany) and hydrophilic silicas marketed under the CAB-O-SIL® and CAB-O-SPERSE® trademarks (Cabot, Boston, Massachusetts), while commercially-available fumed aluminas include, but are not limited to, AEROXIDE® Alu C (Evonik, Germany).

The inventive compositions, optionally, also may comprise one or more optional non-reactive fillers. Illustrative of such fillers are titanium dioxide, talc, zirconia, zinc oxide, calcium carbonate, barium sulfate, graphene, graphene-based particulates and combinations thereof. These other fillers, if included, should be in the form of particulates, and may generally have a BET specific surface area ranging from about 35 to about 400 m²/g.

Acetylene black (e.g., carbon black) may be useful as an additional filler in various embodiments of the invention, particularly when a conductive PSA is desired. Acetylene black is well-known to those skilled in the art and is not surface-treated. Desirably, the acetylene black may have one (and desirably more than one) of the following attributes: a BET specific surface area ranging from about 60 to about 150 m²/gram; and a mean particle size ranging from about 30 to about 50 nm.

Illustrative of commercially available acetylene blacks include, but are not limited to, AB 50%- 01, AB 50%- 03, AB 75%- 01, AB 100%- 01 and ABHC-01 (Soltex, Houston, TX), DENKA BLACK (Denka Co., Ltd., Tokyo, Japan), and Y50A (Orion Engineered Carbons, Houston, Texas).

Crosslinking of the surface-treated fillers is desirably completed via the inclusion of at least one crosslinking agent in the compositions used to prepare a finished PSA. Various crosslinking agents may be used in the inventive compositions, as described in more detail herein. While not desiring to be bound by any particular theory, it is believed that each functional group in the crosslinking agents described herein will react with a functional group present in one or more of the ST fillers (e.g., silane and/or silazane), NST silicas, and, in embodiments wherein an optional resin is included, with a vinyl and/or divinyl functional group therein, as further described herein, and in doing so provide a desired crosslinked structure in the finished PSA.

In embodiments that include a SiH functional crosslinking agent, it is believed that the SiH functional groups in that agent react (and crosslink) with a reactive group (e.g., a methacryloyl group on a silane) in the ST filler (e.g., a ST fumed silica wherein the surface treatment comprises a silane with an unsaturated double bond) via a hydrosilylation reaction. Generally, a hydrosilylation reaction proceeds by adding a silicon-hydrogen (Si—H) bond across an unsaturated carbon-carbon double bond (C═C) of another molecule, resulting in the formation of a silicon-carbon (Si—C) bond. In these embodiments, the foregoing reaction is catalyzed, as will be discussed further herein.

SiH functional crosslinking agents suitable for use in this embodiment of the invention include silanes, siloxanes (including hydrosiloxanes), and more desirably, polymers of methylsiloxanes and di-, tri- and/or octyl-methylsiloxanes, wherein the agent has at least two SiH functional groups. Examples of SiH functional crosslinking agents suitable for use in the present invention include, without limitation, Gelest HMS-301 (25-35% methylhydrosiloxane—dimethylsiloxane copolymer, trimethylsiloxane terminated, 25-35 cSt), Gelest HMS-501 (50-55% (methylhydrosiloxane) 45-50% (dimethylsiloxane) copolymer, trimethylsiloxy terminated), Gelest HMS-151 (15-18% (methylhydrosiloxane) 82-85% (dimethylsiloxane) copolymer, trimethylsiloxy terminated), Gelest HMS-082 (7-9% methylhydrosiloxane)—(91-3% dimethylsiloxane) copolymer, trimethylsiloxy terminated), Gelest HMS-991 (poly(methylhydrosiloxane), trimethyl terminated 15-25 cSt) and Gelest HAM-3012 (25-30% methylhydrosiloxane)—(30-35% octylmethylsiloxane) dimethylsiloxane terpolymer, 20-60 cSt) available from Gelest, Inc. (Morrisville, Pennsylvania) and Silmer HQ-20 available from Siltech (Toronto, Canada).

In embodiments that include a SH functional crosslinking agent, it is believed that the SH functional groups react (and crosslink) with a reactive group (e.g., a methacryloyl group on a silane) in the ST filler (e.g., ST fumed silica wherein the surface-treatment comprises a silane and/or silazane that also may include a double bond). While the crosslinking reaction may be initiated via the application of heat, initiation of the reaction may be provided via UV light with the inclusion of appropriate initiators in the composition.

SH functional crosslinking agents suitable for use in this embodiment of the invention include thiols having at least two SH functional groups. Examples of SH functional crosslinking agents suitable for use in the present invention include, without limitation, pentaerythritol tetrakis (3-mercaptopropionate (PEMP) and trimethylolpropane tris (3-mercaptopropionate (TMMP) available from Kowa American (New York, New York).

In embodiments that include an isocyanate functional crosslinking agent, it is believed that the isocyanate groups react (and crosslink) with a reactive group in a ST filler (e.g., ST fumed silica wherein the surface-treatment comprises a silane with an amino group) as well as with the SiOH on the surface of ST and/or NST silica. Thus, it is believed that the isocyanate functional groups will react with SiOH groups on the ST or NST silica, although there should be more SiOH groups available to react with the isocyanate functional groups on NST silica. The use of this combination of isocyanate functional crosslinking agent and NST and/or ST (even in the absence of an amino group) silica was found to provide various advantages, including, without limitation, desirable static shear strength and relatively low cost, relative to embodiments of the invention that include ST fillers wherein the surface treatments include methacryloyl or amino groups.

Isocyanate functional crosslinking agents suitable for use in embodiments of the invention include amines having at least two isocyanate substituents. Examples of isocyanate functional crosslinking agents suitable for use in the present invention include, without limitation, Desmodur® E28, Desmodur® XP2847, Desmodur® Ultra N3300, Desmodur® N100, Desmodur® N3400, and Desmodur® E1361, available from Covestro (Leverkusen, Germany).

Generally, embodiments that include an isocyanate functional crosslinking agent will not require a catalyst, although if desired, a tin (e.g., dibutyltin dilaurate) or base (e.g., 1,4-diazabicyclo[2.2.2]octane (DABCO), 1,8-Diazabicyclo[5.4.0]undec-7-ene (DBU) catalyst may be included.

The amount of the second crosslinking agent may vary, and desirably may be included in amounts ranging from about 0.3 to about 3 wt. %, more desirably from about 0.7 to about 2.5 wt. %, and even more desirably from about 1to about 2 wt. %, all weight percentages being based on total weight of the non-volatile ingredients in the composition.

Embodiments that include a SiH functional crosslinking agent also require a catalyst. While catalysts may be chosen depending on the crosslinkable groups included on the fillers and crosslinking agents, catalysts comprising platinum are preferred as they are believed to promote a hydrosilylation reaction. Illustrative of suitable platinum catalysts that may be used include, without limitation, platinum complexes of unsaturated siloxanes (Karstedt catalyst), with preferred catalysts including platinum-divinyltetramethyldisiloxane complex; platinum-cyclovinylmethyl-siloxane complex; and platinum-[N-methyl-N′-(trimethoxysilylpropyl)imidazole-2-ylidene] [divinyltetramethyldisiloxane] complex.

The amount of catalyst employed in the aforementioned embodiments may vary, but should be sufficient to assist in the substantially complete crosslinking of the functional groups on the fillers, crosslinking agents and, if present, the optional vinyl-containing resins. In this regard, the catalyst desirably may be included in amounts ranging from about 0.001 to about 0.1 wt. %, desirably from about 0.002 to about 0.05 wt. %, and more desirably from about 0.005 to about 0.02 wt. %, all weight percentages being based on the total weight of the non-volatile ingredients in the composition.

In embodiments of the invention that include a SiH functional crosslinking agent and a catalyst, it was found that the crosslinking reactions as described herein, and in particular the hydrosilylation reactions, may occur at ambient temperatures in a matter of minutes after introduction of the catalyst. Desirably, therefore, these embodiments may include a catalytic inhibitor which provides some control over the speed of the crosslinking reaction, e.g., assisting in increasing the time from catalyst addition to substantially complete crosslinking.

While a variety of catalytic inhibitors may be used, dimethyl fumarate, dimethyl maleate and/or 3,5-dimethyl-1-hexyn-3-ol are desirably used. The inhibitors may be used in any amount suitable for providing the desired period of time from catalyst addition to substantially complete crosslinking, but are commonly added in amounts ranging from about 0.1 to about 1 wt. %, desirably from about 0.15 to about 0.75 wt. %, and more desirably from about 0.2 to about 0.5 wt. %, all weight percentages being based on the total amount of non-volatile ingredients in the composition.

Embodiments of the invention that include a SH functional crosslinking agent do not require a catalyst as they may be initiated by the application of heat, with the associated increase in temperature catalyzing a crosslinking reaction between, it is believed, and at least, the surface-treatment composition and reactive functional groups on the SH functional crosslinking agent, to provide a PIB PSA. If desired, however, a radical initiator may be included, which may assist in catalyzing the crosslinking reaction upon exposure to heat or radiation. Illustrative, and non-limiting examples, of radical initiators which catalyze the reaction upon exposure to heat include VAZO™ Free Radical Initiators, e.g., 52, 64, 67, 88 (Chemours™, Wilmington, Delaware), and those which catalyze the reaction upon exposure to UV include photoinitiators such as the SpeedCure series, available from Lambson (Wetherby, UK), or the Darocure™ series, available from BASF (Florham Park, New Jersey).

The amount of radical initiator used in these compositions may vary, but should be sufficient to assist in the substantially complete crosslinking of the surface-treated fillers with the SH functional crosslinking agent. In this regard, the initiator desirably may be included in amounts ranging from about 0.001 to about 2 wt. %, desirably from about 0.01 to about 1 wt. %, and more desirably from about 0.1 to about 0.5 wt. %, all weight percentages being based on the total weight of the non-volatile ingredients in the composition.

Radiation useful in initiating a crosslinking reaction in embodiments in which exposure to radiation initiates the radical initiator includes UV radiation, desirably UV-A and UV-B radiation (about 280 to about 400 nm).

Tackifiers comprise an optional, yet desirable, ingredient in certain embodiments of the invention. Generally speaking, tackifiers are substances that enhance the tack of a PIB PSA relative to a PIB PSA without the tackifier. Tack may be described as a measure of how quickly an adhesive bond is formed when two surfaces are brought together with light pressure. The faster two surfaces bond, the higher the tack. The inclusion of a tackifier also may permit the preparation of a PIB PSA exhibiting an acceptable adhesion onto a polar surface using a relatively lower amount of PIB resin. Generally, the inclusion of tackifiers in the inventive PSA compositions described herein was observed to have a limited effect on the static shear strength of the compositions.

When included, a tackifier may be included in any amount, but is desirably included in amounts ranging from about 1 to about 30 wt. %, and more desirably from about 5 to about 25 wt. %, and even more desirably from about 10 to about 20 wt. %, based on the non-volatile components in the filled PIB PSA. Illustrative of tackifiers that may be useful in the various embodiments of the invention include terpenes, e.g., terpene phenolic esters, aliphatic- or aromatic-modified C₅ to C₉ hydrocarbons, rosin esters, coumarine-indene resins PIBs having relatively low vMW (from about 500 vMW to about 5,000 vMW) and mixtures thereof. Illustrative of suitable commercially available tackifiers include, but are not limited to, Arkon P and M Series hydrogenated hydrocarbon resins (Arakawa Chemical, Japan) and Indopol® H Series polybutenes (Palmer Holland, USA).

The following tables provide illustrative compositions contemplated by the present invention, which compositions may be suitable for use in one or more of the methods described herein. All weight percents in the tables are based on the total weight of the non-volatile ingredients in each composition. It should be appreciated that, if desired, other optional ingredients may be included in these compositions.

Table A describes ingredients and amounts thereof for providing PSAs useful in the various methods contemplated by the present invention, wherein the composition includes a SiH functional crosslinking agent.

TABLE A

| | Formulation 1 | Formulation 2 | Formulation 3 |
|---|---|---|---|
| Ingredient | wt. % | wt. % | wt. % |
| N100 | 10-40 | 10-30 | 15-25 |
| B12 | 20-70 | 25-65 | 30-60 |
| ST Fumed | 5-30 | 10-25 | 15-20 |
| Silica | | | |
| Optional | 0.1-20 | 0.1-15 | 0.1-10 |
| Functional | | | |
| Resin | | | |
| SiH Functional | 0.1-15 | 0.1-12 | 0.1-10 |
| Crosslinking | | | |
| Agent | | | |
| Optional | 1-30 | 5-25 | 10-20 |
| Tackifier | | | |
| Catalyst | 0.001-5 | 0.001-2 | 0.005-1 |
| Inhibitor | 0.05-5 | 0.1-2 | 0.1-1 |

Table B describes ingredients and amounts thereof for providing PSAs useful in the various methods contemplated by the present invention, wherein the composition includes a SH functional crosslinking agent.

TABLE B

| | Formulation 1 | Formulation 2 | Formulation 3 |
|---|---|---|---|
| Ingredient | wt. % | wt. % | wt. % |
| N100 | 10-40 | 10-30 | 15-25 |
| B12 | 20-70 | 25-65 | 30-60 |
| ST Fumed | 5-30 | 8-25 | 15-20 |
| Silica | | | |
| SH Functional | 0.1-15 | 0.1-10 | 0.1-5 |
| Crosslinking | | | |
| Agent | | | |
| Optional | 0.1-20 | 0.1-15 | 0.1-10 |
| Functional | | | |
| Resin | | | |
| Optional | 1-30 | 5-25 | 10-20 |
| Tackifier | | | |
| Radical | 0.01-5 | 0.01-2.5 | 0.01-1 |
| Initiator | | | |

Tables C and D describe ingredients and amounts thereof for providing PSAs useful in the various methods contemplated by the present invention, wherein the composition includes an isocyanate crosslinking agent.

TABLE C

| | Formulation 1 | Formulation 2 | Formulation 3 |
|---|---|---|---|
| Ingredient | wt. % | wt. % | wt. % |
| N100 | 10-40 | 10-30 | 15-25 |
| B12 | 20-70 | 25-65 | 30-60 |
| ST Fumed | 5-30 | 8-25 | 15-20 |
| Silica | | | |
| Optional | 0.1-20 | 0.1-15 | 0.1-10 |
| Functional | | | |
| Resin (Polyol, | | | |
| Polyamine | | | |
| and/or | | | |
| Polythiol) | | | |
| Optional | 1-30 | 5-25 | 10-20 |
| Tackifier | | | |
| Isocyanate | 0.1-20 | 0.1-15 | 0.1-10 |
| Functional | | | |
| Crosslinking | | | |
| Agent | | | |
| Optional | 0.01-5 | 0.01-2.5 | 0.01-1 |
| Catalyst | | | |

TABLE D

| | Formulation 1 | Formulation 2 | Formulation 3 |
|---|---|---|---|
| Ingredient | wt. % | wt. % | wt. % |
| N100 | 10-40 | 10-30 | 15-25 |
| B12 | 20-70 | 25-65 | 30-60 |
| NST Fumed | 5-30 | 8-25 | 15-20 |
| Silica | | | |
| Optional | 0.1-20 | 0.1-15 | 0.1-10 |
| Functional | | | |
| Resin (Polyol, | | | |
| Polyamine | | | |
| and/or | | | |
| Polythiol) | | | |
| Optional | 1-30 | 5-25 | 10-20 |
| Tackifier | | | |
| Isocyanate | 0.1-20 | 0.1-15 | 0.1-10 |
| Functional | | | |
| Crosslinking | | | |
| Agent | | | |
| Optional | 0.01-5 | 0.01-2.5 | 0.01-1 |
| Catalyst | | | |

Certain embodiments of the present invention contemplate a composition comprising, consisting essentially of, or consisting of: (a) about 10 to about 40, about 10 to about 30, or about 15 to about 25 wt. % of a PIB resin having a vMW ranging from 300,000 to about 3,000,000 g/mol; (b) about 20 to about 70, about 25 to about 65, or about 30 to about 60 wt. % of a PIB resin having a vMW ranging from about 35,000 to about 100,000 g/mol; (c) about 5 to about 30, about 10 to about 25 or about 15 to about 20 wt. % of a ST filler wherein the surface treatment comprises, consists essentially of, or consists of a silane, a silazane or a combination thereof, and desirably with an unsaturated double bond, (d) about 0.1 to about 15, about 0.1 to about 12, or about 0.1 to about 10 wt. % of a SiH functional crosslinking agent, and (e) about 0.001 to about 5, about 0.001 to about 2 and about 0.005 to about 1 wt. % of a crosslinking catalyst, wherein the composition optionally may further comprise about 0.1 to about 20, 0.1 to about 15 or 0.1 to about 10 wt. % of a functional resin, about 0.05 to about 5, about 0.1 to about 2 or about 0.1 to about 1 wt. % of a catalyst inhibitor, and/or about 1 to about 30 wt. %, about 5 to about 25 or about 10 to about 20 wt. % of a tackifier. The foregoing embodiments also may comprise, if desired, a weight ratio of resin (a) to resin (b) ranging from about 1:1 to about 1:5, desirably from about 1:1 to about 1:4, and more desirably about 1:2 to about 1:3. The foregoing weight percentages and weight ratios are based on the non-volatile ingredients in the compositions.

Another embodiment of the present invention contemplates a composition comprising, consisting essentially of, or consisting of: (a) about 10 to about 40, about 10 to about 30, or about 15 to about 25 wt. % of a PIB resin having a vMW ranging from 300,000 to about 3,000,000 g/mol; (b) about 20 to about 70, about 25 to about 65, or about 30 to about 60 wt. % of a PIB resin having a vMW ranging from about 35,000 to about 100,000 g/mol; (c) about 5 to about 30, about 10 to about 25 or about 15 to about 20 wt. % of a ST filler wherein the surface treatment comprises, consists essentially of, or consists of a silane, a silazane or a combination thereof, and desirably with an unsaturated double bond, and (d) about 0.1 to about 15, about 0.1 to about 10, or about 0.1 to about 5 wt. % of a SH functional crosslinking agent, wherein the composition optionally may further comprise about 0.1 to about 20, 0.1 to about 15 or 0.1 to about 10 wt. % of a functional resin, about 0.001 to about 5, about 0.01 to about 2.5 or about 0.01 to about 1 wt. % of a radical initiator, and/or about 1 to about 30 wt. %, about 5 to about 25 or about 10 to about 20 wt. % of a tackifier. The foregoing embodiments also may comprise, if desired, a weight ratio of resin (a) to resin (b) ranging from about 1:1 to about 1:5, desirably from about 1:1 to about 1:4, and more desirably about 1:2 to about 1:3. The foregoing weight percentages and weight ratios are based on the non-volatile ingredients in the compositions.

Yet another embodiment of the present invention contemplates a composition comprising, consisting essentially of, or consisting of: (a) about 10 to about 40, about 10 to about 30, or about 15 to about 25 wt. % of a PIB resin having a vMW ranging from 300,000 to about 3,000,000 g/mol; (b) about 20 to about 70, about 25 to about 65, or about 30 to about 60 wt. % of a PIB resin having a vMW ranging from about 35,000 to about 100,000 g/mol; (c) about 5 to about 30, about 10 to about 25 or about 15 to about 20 wt. % of a ST filler wherein the surface treatment comprises, consists essentially of, or consists of a silane, a silazane or a combination thereof, and desirably (i) with an amino group or, alternatively, (ii) without a methacryloyl or amino group, and (d) about 0.1 to about 20, about 0.1 to about 15, or about 0.1 to about 10 wt. % of an isocyanate functional crosslinking agent, wherein the composition optionally may further comprise about 0.1 to about 20, 0.1 to about 15, or 0.1 to about 10 wt. % of a functional polyol, polyamine and/or polythiol resin, about 0.01 to about 5, about 0.01 to about 2.5 or about 0.01 to about 1 wt. % of a catalyst, and/or about 1 to about 30 wt. %, about 5 to about 25 or about 10 to about 20 wt. % of a tackifier. The foregoing embodiments also may comprise, if desired, a weight ratio of resin (a) to resin (b) ranging from about 1:1 to about 1:5, desirably from about 1:1 to about 1:4, and more desirably about 1:2 to about 1:3. The foregoing weight percentages and weight ratios are based on the non-volatile ingredients in the compositions.

Another embodiment of the present invention contemplates of the present invention contemplate a composition comprising, consisting essentially of, or consisting of: (a) about 10 to about 40, about 10 to about 30, or about 15 to about 25 wt. % of a PIB resin having a vMW ranging from 300,000 to about 3,000,000 g/mol; (b) about 20 to about 70, about 25 to about 65, or about 30 to about 60 wt. % of a PIB resin having a vMW ranging from about 35,000 to about 100,000 g/mol; (c) about 5 to about 30, about 8 to about 25 or about 15 to about 20 wt. % of a NST filler, and (d) about 0.1 to about 20, about 0.1 to about 15, or about 0.1 to about 10 w. % of an isocyanate crosslinking agent, wherein the composition optionally may further comprise about 0.1 to about 20, 0.1 to about 15, or 0.1 to about 10 wt. % of a functional polyol resin, about 0.01 to about 5, about 0.01 to about 2.5 or about 0.01 to about 1 wt. % of a catalyst, and/or about 1 to about 30 wt. %, about 5 to about 25 or about 10 to about 20 wt. % of a tackifier. The foregoing embodiments also may comprise, if desired, a weight ratio of resin (a) to resin (b) ranging from about 1:1 to about 1:5, desirably from about 1:1 to about 1:4, and more desirably about 1:2 to about 1:3. The foregoing weight percentages and weight ratios are based on the non-volatile ingredients in the compositions.

The PSAs described herein do not contemplate the inclusion of clays as fillers, and as such the amount of any clay is limited. For example, in certain embodiments, clay fillers, if present, comprise no more than about 1 wt. % of, more desirably no more than about 0.5 wt. % of, even more desirably no more than about 0.1 wt. % of, and most desirably are not detectable in, the inventive PSAs.

The PSAs of the present invention may be prepared in accordance with any standard mixing methodologies known in the art as regarding equipment and conditions (e.g., temperature, humidity).

The amount of ingredients used to prepare the embodiments of the present invention are based on the weight of the non-volatile components in a filled PIB PSA, i.e., the amounts used to prepare the composition before dilution. In this regard, and as is well understood by persons skilled in the art, the filled PIB PSAs may be diluted with a volatile component (e.g., toluene, heptane) to a solids content of between about 10 to about 20 wt. % and mixed until a homogenous composition is provided. This dilution, which lowers the viscosity of the filled PIB PSA, is desired as it enables the filled PIB PSA to be coated onto a surface and provide a substantially uniform coated layer. After coating, the diluent is volatilized, leaving the filled PIB PSA as a film, ready for use. Alternatively, the compositions may be applied in the absence of any volatile ingredient.

The order of addition of certain ingredients is important to obtain the desirable properties in the finished adhesive. In this regard, the crosslinking of the crosslinkable filler (and, if included, the vinyl- or divinyl-containing PIB resin) is to be completed after the filler has been mixed with, at least, the PIB resins and, desirably, with each of the other ingredients (with the exception of a catalyst and, when included, an isocyanate crosslinking agent, each of which should be added in the final mixing step). To achieve this, it is desirable to thoroughly mix the PIB resins with the filler (any optional ingredients also may be added at this time, e.g., colorants). In embodiments that include a catalyst (and, in certain embodiments, a catalytic inhibitor), the inhibitor (if any) may be introduced (with mixing) into the resin/filler mixture, followed by the addition, with mixing, of the crosslinking catalyst.

The PSAs of the present invention may be applied onto a variety of flexible and inflexible backing materials using conventional coating techniques to produce adhesive-coated materials. Flexible substrates are defined herein as any material which is conventionally utilized as a tape backing or may be of any other flexible material. Examples include, but are not limited to, plastic films such as polypropylene, polyethylene, ethylene vinyl acetate (EVA), polyvinyl chloride, polyester (polyethylene terephthalate), polycarbonate, polymethyl(meth)acrylate (PMMA), cellulose acetate, cellulose triacetate, and ethyl cellulose. Foam backings may be used. Examples of inflexible substrates include, but are not limited to, metal, metallized polymeric film, indium tin oxide coated glass and polyester, PMMA plate, polycarbonate plate, glass, or ceramic sheet material. The adhesive-coated sheet materials may take the form of any article conventionally known to be utilized with adhesive compositions such as labels, tapes, signs, covers, marking indices, display components, touch panels, and the like. Flexible backing materials having microreplicated surfaces are also contemplated.

The PSA also may be used as a component of a pressure-sensitive adhesive transfer tape in which at least one layer of the adhesive is disposed on a release liner for application to a secondary substrate at a later time. The PSA also may be provided as a single-coated or double-coated tape in which the adhesive is disposed on a permanent backing. Backings may be made from plastics (e.g., polypropylene, including biaxially oriented polypropylene, vinyl, polyethylene, ethylene vinyl acetate (EVA), polyester such as poly(ethylene terephthalate), nonwovens (e.g., papers, cloths, nonwoven scrims), metal foils, foams (e.g., polyacrylic, polyethylene, polyurethane, neoprene), and the like.

Foams are commercially available from various suppliers such as 3M, Voltek, Sekisui, and others. The foam may be formed as a coextruded sheet with the adhesive on one or both sides of the foam, or the adhesive may be laminated to it. When the adhesive is laminated to a foam, it may be desirable to treat the surface to improve the adhesion of the adhesive to the foam or to any of the other types of backings. Such treatments are typically selected based on the nature of the materials of the adhesive and of the foam or backing and include primers and surface modifications (e.g., corona treatment, surface abrasion). Additional tape constructions include those described in U.S. Pat. No. 5,602,221 (Bennett et al.). Those skilled in the art will also appreciate that other additives such as antioxidants, stabilizers, and colorants may be blended with the adhesive to provide additional beneficial properties

For a single-sided tape, the side of the backing surface opposite the side onto which the adhesive is disposed is typically coated with a suitable release material. Release materials are known and include materials such as, for example, silicone, polyethylene, polycarbamate, polyacrylics, and the like. For double-coated tapes, another layer of adhesive is disposed on the backing surface opposite the side onto which the inventive adhesive invention is disposed. The other layer of adhesive may be different from the adhesive of the invention, e.g., a conventional acrylic PSA, or it may be the same adhesive, with the same or a different composition. Double-coated tapes are typically carried on a release liner.

The above-described PSA (diluted) compositions may be applied onto a substrate using conventional coating techniques modified as appropriate to the particular substrate. For example, these compositions can be applied to a variety of solid substrates by methods such as roller coating, flow coating, dip coating, spin coating, spray coating, knife coating, and die coating. These various methods of coating allow the compositions to be placed on the substrate at variable thicknesses thus allowing a wider range of use of the compositions. Coating thicknesses may vary, but coating thicknesses of 0.1 to about 10 mils (dry thickness), preferably about 0.1 to 3 mils, and more preferably about 0.1 to about 1 mil (dry thickness), are contemplated.

The PSAs contemplated by the present invention provide one or more advantageous properties, including, without limitation, desirable static shear strength, relatively low creep resistance, peel strength, liner release, and WVTR values.

### Preparation of the Adhesives for Testing

The filled PIB PSAs used in the testing described herein were prepared by introducing a specified amount of each ingredient (as described in the Tables), with the exception of the crosslinking agent if included (and, if desired, the catalyst and inhibitor), into a container, diluting the contents with toluene or heptane to a solids content of about 14 to about 20%, and mixing the diluted contents using disperser blades (3500 rpm) for 15 minutes at room temperature. Thereafter, the crosslinking agent if included (and, if desired, the catalyst and inhibitor) is added, and mixed at 3000 rpm for two minutes, thereby providing a liquid composition. The resulting liquid composition was coated onto a silicone release liner using a knife-over-roll down coater (e.g., ChemInstruments Laboratory Drawdown Coater) at a thickness which, after the diluent is volatilized, provides a dry film thickness of 1 mil (or 0.2 mils for coatings containing acetylene (carbon) black). Volatilization then proceeded by baking the liquid composition at 65° C. for 3 min, and then at 150° C. for 5 min. The resulting exposed PSA adhesive was then covered by a second release liner (e.g., a silicone release liner or polyethylene terephthalate (e.g., PET) release liner) to provide a PSA test specimen.

### Static Shear Strength

The static shear strength of a PSA is determined as follows.

A Pressure Sensitive Tape Council (PSTC) stainless steel (SS) panel onto which the adhesive is to be applied is cleaned with high purity urethane grade 2-butanone. A 0.5 inch×3 inch PSA test specimen (prepared as described above) is laminated onto an area of 0.5 in×0.5 in (12.7 mm×12.7 mm) of the PSTC stainless steel panel using a 4.5 lb, 80 durometer, hardness roller.

After a 30-minute dwell period, the SS panel onto which the test specimen is adhered is mounted vertically within a chamber that is pre-heated to 70° C. (and maintained at 70° C. for the duration of the testing), and static shear testing is initiated by hanging a 500 gram weight from the portion of the PSA test specimen that is not adhered to the SS panel. The time elapsed (minutes) until the weight falls is recorded as the static shear strength of the PSA.

Static shear strengths of various embodiments of the inventive PSAs, pursuant to this testing methodology, are described herein, but generally may be at least about 10, 20, 50, 100. 200, 500, 1,000, 2,000, 5,000 or 10,000 minutes. Testing was terminated upon reaching 10,000 minutes (almost 7 days) for practical reasons—10,000 minutes, therefore, may serve as an acceptable upper limit of static shear strength for purposes of describing the present invention. It should be understood, however, that various embodiments of the invention remained adhered at 10,000 minutes, and thus would be expected to provide static shear strengths exceeding 10,000 minutes.

### Peel Strength

The peel strength of a PSA is determined as follows.

The PSA to be tested was prepared in the same manner described previously.

A Pressure Sensitive Tape Council (PSTC) stainless steel (SS) panel onto which the adhesive is to be applied is cleaned with high purity urethane grade 2-butanone. A 1 in×10 in PSA test specimen (prepared as described above) is laminated onto the PSTC SS panel using a 4.5-lb, 80 durometer, hardness roller.

After a 15-minute dwell period, peel testing is initiated (with the test specimen at room temperature and ambient humidity) by pulling the tape from the PSTC SS plate at a rate of 12 inches/minute at an angle of 180 degrees. The load and displacement commonly increase to a maximum over the first 1 inch of the test, and then remain constant until the test was complete. The peel strength is determined by averaging the load (oz) observed between one- and five-inch displacement on the panel (based on a 1 inch sample width), thereby providing an oz/in value which is the PSA peel strength.

The peel strength of various embodiments of the inventive PSAs, pursuant to this testing methodology, are described herein, but generally may be at least about 10, 20, 30, 40, 50, 60, 70, 100, 150 or 200 oz/inch; 200 oz/inch may serve as the upper limit for peel strength for purposes of generally describing the present invention.

### Water Vapor Transmission Rate

The test for water vapor transmission rate (WVTR) of a PSA is performed using a Mocon Permatran-W 3/33 MA (Ametech-Mocon, Brooklyn Park, MN) as follows

The PSA to be tested was prepared in the same manner described previously. Prior to initiating testing in the Mocon Permatran device, a liner covering the PSA is removed, the PSA is placed onto a Celgard® sheet, and the PSA sample is placed on a Mocon 032-076 aluminum foil sheet to cover a hole in the sheet of 1 cm² and subjected to testing. The WVTR value for the PSA is that which is identifiable as the plateau value, which is commonly reached on or after about 12-36 hours. The WVTR of various embodiments of the inventive PSAs, pursuant to this testing methodology, are described herein, but generally may have a WVTR that is no more than about 100, 80, 70, 50, 40, 30, 25 or 10 g-mil/m²/day, wherein 0.1 g-mil/m²/day may serve as a lower limit for WVTR for purposes of generally describing the present invention.

### Tight Liner Release

The test for tight liner release of a PSA is performed using a TMI Lab Master® Release & Adhesion Tester (New Castle, Delaware) as follows.

The PSA to be tested was prepared in the same manner described previously.

The testing is carried out in a controlled temperature (70° F.) and humidity (50% RH) environment. A 2 in×10 in PSA test specimen is subjected to testing in the device (300 inches/min at 180 degrees), wherein the release of the adhesive from the liner onto which the PSA composition was deposited (which may be referred to as the “tight” liner) is determined based on an average load (oz) between 1- and 5-inch displacement (noting the 2 inch sample width) thereby providing a gram/2 inch value which is the tight liner release.

The liners used in this test, as identified in the tables, are: AR-W2: Adhesives Research W-5002 (silicone); AR-W4: Adhesives Research W-5004 (silicone with tighter release relative to AR-W2); AR-R6: Mitsubishi 2PKRN 1.5 mil PET (silicone coated); and AR-R7: Mitsubishi 2PKRN 2.0 mil PET (silicone coated).

The tight liner release of various embodiments of the inventive PSAs, pursuant to this testing methodology, are described herein, but generally may have a (tight) liner release that is less than about 100, 90, 80, 70, 50, 40, 30 or 20 grams/2 inch, wherein about 5 grams/2 inch may serve as a lower limit for (tight) liner release for purposes of generally describing the present invention.

### Conductivity

The conductivity of the PSAs was assessed using a Keithley Micro-ohmmeter (Model 580) as follows.

The PSA to be tested was prepared in the same manner described previously, with the adhesive then being applied onto a removable AR-W4 liner at an initial thickness of 5 or 25.4 μm (the latter also referred to as being 1 mil in thickness), and then covered by a second removable Mitsubishi 2PKRN 2.0 mil PET liner, to provide a sample.

The testing protocol commenced by removing the second liner from the sample to expose one side of the PSA layer. A gold-plated stainless-steel electrode measuring 1 in×1 in was brought into contact with the freshly exposed PSA adhesive layer and pressed down firmly. While pressing down firmly, the PSA adhesive and AR-W4 liner were cut to the shape of the electrode, and separated from the larger sample. Thereafter, the AR-W4 liner was separated from the freshly cut 1 in² PSA adhesive/AR-W4 liner, and a second gold-plated stainless-steel electrode was pressed onto the freshly exposed PSA adhesive, wherein both electrodes were aligned edge-to-edge and faced each other to provide an assembled electrode.

The assembled electrode was then placed in a jig that allowed equal pressure to be applied onto the electrode, while allowing room for attaching conductive alligator clips. Thereafter, a current of 100 mA was applied to the electrodes, and a resistivity value (in milliohm) was obtained from the instrument at 11 lbs of force after waiting 30 seconds to allow the sample to equilibrate. Lower resistivity values correspond to higher sample conductivity, with higher conductivity values being desirable for compositions containing acetylene black.

For purposes of the various embodiments of the inventive PSAs, a conductive PSA may have a resistivity value of about 0.25 to about 250 ohms (as determined using the protocol described herein).

Alternatively, the well-known four-point method may be utilized to assess the volume resistivity, surface resistivity, and conductivity of a PSA. The method, in general, requires a probe with four points of known diameters spaced apart relative to one another to be brought into contact with a subject PSA film, at which point a known current is applied to the two outer points, with the remaining two inner points being in communication with a voltmeter. The resistivity may be determined via the following known equation:

$$ρ = 2 π S ( V / I )$$

wherein ρ=resistivity (ohm·cm), S=needle spacing (cm), V=voltage between the inner probes (V), and I=Current through the outer probes. As is further known, if the thickness of a film to be tested is less than 5 times the point spacing, a correction factor should be applied. Also, if the thickness of the film is equal to or greater than 5 times the point spacing, the correction factor to be applied to the formula is less than 0.1%.

Using the four-point method, the volume resistivity of the PSA desirably may range from about 1 to about 1000 ohm·cm.

The following examples are provided to illustrate, and not limit, the scope of the present invention.

### EXAMPLE 1

Several PIB PSA compositions (which include OPPANOL®N100 as the high vMW PIB resin and OPPANOL® B12 as the low vMW PIB resin) with varying amounts of a surface treated fumed silica (ST Fumed Silica), a SiH crosslinking agent, a platinum catalyst and catalyst inhibitor, were prepared and tested relative to an adhesive (1-A) that does not contain any crosslinking agent. The ingredients used to prepare the adhesives are set forth in Table 1, wherein the amount of each ingredient is set forth as a weight percent based on the total weight of the non-volatile ingredients in the composition. The process used for preparing these adhesives is described in “Preparation of the Adhesives for Testing.”

After preparation, the adhesives were tested as described herein and analyzed for static shear strength (70° C., 500 gram weight), with certain of the adhesive further tested for their adhesion to a stainless steel surface (peel strength) and moisture barrier (WVTR) properties in accordance with the testing protocols described herein. The values obtained are set forth in Table 1.

TABLE 1

| | | | | | | | | | | | | | | Static | | |
|---|---|---|---|---|---|---|---|---|---|---|---|---|---|---|---|---|
| | High | Low | | | | | | | | | | | | Shear | Peel | |
| | vMW | vMW | | | | | | | | | | | | Strength | to | WVTR |
| | PIB | PIB | | | | | | | | | | | | (70° C., | SS | (g-mil/ |
| Formula | Resin | Resin | | | | | | | | | | | | 500 g) | (oz/ | m²/ |
| ID | (N100) | (B12) | R711 | 301 | 501 | 151 | 082 | 991 | 3012 | IIQ20 | 450A | DMM | Pt | (mins) | in) | day) |
| 1-A | 19.6 | 63.8 | 16.6 | | | | | | | | | | | 25.6 | 42.4 | |
| 1-1 | 25.4 | 50.8 | 21.5 | 1.79 | | | | | | | | 0.48 | .01 | 0.8 | | |
| 1-2 | 19.1 | 57.2 | 21.5 | 1.79 | | | | | | | | 0.48 | .01 | 20 | 0-1 | |
| 1-3 | 19.8 | 59.5 | 18.7 | 1.56 | | | | | | | | 0.41 | .008 | 77.1 | 6.6 | |
| 1-4 | 20.7 | 62.1 | 15.6 | 1.30 | | | | | | | | 0.30 | .007 | 58.1 | 28.2 | |
| 1-5 | 22.6 | 67.9 | 8.5 | 0.71 | | | | | | | | 0.19 | .004 | 5.9 | 40.2 | |
| 1-6 | 19.9 | 59.8 | 15.6 | 2.0 | | | | | | | 2.4 | 0.26 | .005 | 506 | 10.3 | |
| 1-7 | 19.4 | 58.2 | 15.6 | 1.9 | | | | | | | 4.7 | 0.25 | .005 | 34.8 | 6.3 | |
| 1-8 | 19.2 | 62.3 | 16.2 | 2.0 | | | | | | | | 0.27 | .005 | 94.2 | 16.3 | 46.3 |
| 1-9 | 18.8 | 61.1 | 15.9 | | | 4.0 | | | | | | 0.26 | .005 | 78.0 | 13.2 | |
| 1-10 | 19.4 | 62.9 | 16.4 | | 1.1 | | | | | | | 0.27 | .005 | 70.1 | 19.2 | |
| 1-11 | 18.2 | 59.0 | 15.4 | | | | 7.2 | | | | | 0.26 | .005 | 62.5 | 19.4 | 34.8 |
| 1-12 | 19.3 | 62.8 | 16.4 | | | | | | | 1.3 | | 0.27 | .005 | 86.6 | 27.0 | 26.1 |
| 1-13 | 19.5 | 63.2 | 16.5 | | | | | 0.6 | | | | 0.27 | .005 | 85.9 | 14.3 | |
| 1-14 | 19.1 | 62.0 | 16.2 | | | | | | 2.5 | | | 0.27 | .005 | 60.6 | 29.4 | |
| 1-15 | 19.2 | 62.5 | 16.3 | | 1.7 | | | | | | | 0.27 | .005 | 108.4 | 10.0 | |
| 1-16 | 19.5 | 63.2 | 16.5 | | 0.6 | | | | | | | 0.27 | .005 | 81.4 | 26.6 | |
| 1-17 | 19.1 | 62.2 | 16.2 | | 2.2 | | | | | | | 0.27 | .005 | 104.8 | 5.2 | |

R711 = (AEROSIL ® R711): fumed silica surface treated with a composition comprising methacrylsilane (includes a methacryloy1 group)
301 = (Gelest HMS-301): a SiH functional crosslinking agent: 25-35% methylhydrosiloxane—dimethylsiloxane copolymer, trimethylsiloxane terminated, 25-35 cSt
501 = (Gelest HMS-501): a SiH functional crosslinking agent—50-55% (methylhydrosiloxane) 45-50% (dimethylsiloxane) copolymer, trimethylsiloxy terminated
151 = (Gelost HMS-151): a SiH functional crosslinking agent—15-18% (methylhydrosiloxanc) 82-85% (dimethylsiloxanc) copolymer, trimethylsiloxy terminated
082 = (Gelest HMS-082): a SiH functional crosslinking agent—(7-9% methylhydrosiloxane)—(91-3% dimethylsiloxane) copolymer, trimethylsiloxy terminated
991 = (Gelest HMS-991): a SiH functional crosslinking agent—poly(methylhydrosiloxane), trimethyl terminated15-25 cSt
3012 = (Gelest HAM-3012)—(25-30% methylhydrosiloxane)—(30-35% octylmethylsiloxane) dimethylsiloxane terpolymer, 20-60 cSt
HQ20 = (Silmer HQ 20): a SiH functional crosslinking agent—silicic acid (H4SiO4), tetraethyl ester, reaction products with chlorodimethylsilane
450A = (Kaneka EP450A): a di-vinyl functional PIB
DMM = (Sigma Aldrich): dimethyl maleate
Pt = (Gelest SIP 6831.2LC, a catalyst): platinum-divinyltetramethyldisiloxane complex; 2% Pt in xylene
Each composition was prepared to comprise about 15 to about 20 wt. % solids in toluene.

The data provided in this example demonstrates that the compositions with a crosslinked structure provided enhanced static shear strength relative to a comparator adhesive (A) which does not contain a crosslinking agent (and which, therefore, is not crosslinked), particularly when a SiH functional crosslinking agent was added to the composition.

### EXAMPLE 2

Several PIB PSA compositions (which include OPPANOL®N100 as the high vMW PIB resin and OPPANOL®B12 as the low vMW PIB resin) with a surface treated fumed silica (ST Fumed Silica), wherein the surface treatment composition comprises methacrylsilane having an unsaturated double bond, a SH functional crosslinking agent, a tackifier, and a free radical initiator that is initiated by heat were prepared and tested relative to an adhesive (2-A) that does not contain any crosslinking agent. The ingredients used to prepare the adhesives are set forth in Table 2, wherein the amount of each ingredient is set forth as a weight percent based on the total weight of the non-volatile ingredients in the composition. The process used for preparing these adhesives is described in “Preparation of the Adhesives for Testing.”

After preparation, the adhesives were tested as described herein and analyzed for static shear strength (70° C., 500 gram weight), adhesion to a stainless steel surface (peel strength), tight liner release, and (for some adhesives) moisture barrier (WVTR) properties in accordance with the testing protocols described herein. The values obtained are set forth in Table 2.

This example demonstrates that the compositions with a crosslinked structure provided enhanced static shear strength relative to a non-crosslinked adhesive (2-A), particularly when the SH functional crosslinking agent was included in amounts ranging from about 0.1 to about 5 wt. % Such compositions further exhibited acceptable peel strength, tight liner release, and WVTR. It was surprisingly found that including a SH crosslinking agent in an amount of 10 wt. % did not confer any benefit in static shear strength or other properties relative to the non-crosslinked comparator adhesive (2-A).

TABLE 2

| | | | | | | | | | | | Tight | |
|---|---|---|---|---|---|---|---|---|---|---|---|---|
| | | | | | | | | | | | Liner | |
| | High | Low | | | | | | Solids | Static | | Release | |
| | vMW | vMW | | | | | | wt. % | shear | Peel | (silicone | WVTR |
| | PIB | PIB | | | | | | (toluene | 70° C., | to | liners— | (g-mil/ |
| Formula | Resin | Resin | | | | VAZO | VAZO | as | 500 g | SS | AR-W4) | m²/ |
| ID | (N100) | (B12) | R711 | PEMP | TMMP | 67 | 52 | solvent) | (mins) | (oz/in) | (g/2 in) | day) |
| 2-A | 23.6 | 59.1 | 17.3 | | | | | 18.0% | 47.0 | 55.6 | 27.6 | 9.6 |
| 2-1 | 23.6 | 58.9 | 17.2 | 0.1 | | 0.2 | | 18.0% | 92.0 | 53.7 | 26.5 | |
| 2-2 | 23.5 | 58.8 | 17.2 | 0.3 | | 0.2 | | 18.0% | 118.0 | 54.2 | 27.0 | 7.3 |
| 2-3 | 23.5 | 58.6 | 17.1 | 0.6 | | 0.2 | | 18.0% | 124.8 | 56.9 | 25.6 | 9.6 |
| 2-4 | 23.3 | 58.3 | 17.0 | 1.2 | | 0.2 | | 18.0% | 84.8 | 52.9 | 28.2 | |
| 2-5 | 22.9 | 57.4 | 17.1 | 2.4 | | 0.2 | | 18.0% | 97.9 | 56.0 | 26.7 | |
| 2-6 | 22.3 | 55.8 | 17.0 | 4.6 | | 0.2 | | 18.0% | 97.9 | 55.1 | 27.6 | |
| 2-7 | 20.7 | 51.9 | 17.0 | 10.0 | | 0.2 | | 18.0% | 39.3 | 55.8 | 27.7 | 13.7 |
| 2-8 | 23.5 | 58.7 | 17.2 | 0.6 | | | | 18.0% | 66.4 | 50.2 | 25.9 | |
| 2-9 | 23.6 | 59.0 | 17.2 | | | 0.2 | | 18.0% | 33.9 | 51.6 | 26.4 | 7.1 |
| 2-10 | 23.6 | 58.9 | 17.2 | | 0.1 | 0.2 | | 18.0% | 61.1 | 54.6 | 25.2 | |
| 2-11 | 23.5 | 58.6 | 17.1 | | 0.6 | 0.2 | | 18.1% | 66.8 | 53.8 | 26.1 | |
| 2-12 | 23.3 | 58.3 | 17.0 | | 1.2 | 0.2 | | 18.2% | 43.6 | 49.3 | 25.8 | 9.9 |
| 2-13 | 23.5 | 58.6 | 17.1 | 0.6 | | | 0.2 | 18.2% | 160.2 | 43.4 | 25.0 | 7.1 |
| 2-14 | 23.4 | 58.4 | 17.1 | 0.6 | | 0.6 | | 18.2% | 84.5 | 48.5 | 24.8 | |
| 2-15 | 23.3 | 58.1 | 17.0 | 0.6 | | 1.0 | | 18.3% | 97.9 | 46.6 | 24.8 | 9.0 |

R711 = (AEROSIL ® R711): fumed silica surface treated with a composition comprising methacrylsilane (includes a methacryloyl group)
PEMP: pentaerythritol tetrakis (3-mercaptopropionate)
TMMP: trimethylolpropane Tris (3-mercaptopropionate)
VAZO67: an initiator comprising a substituted azonitrile compound
VAZO52: an initiator comprising a substituted azonitrile compound

### EXAMPLE 3

Several PIB PSA compositions (which include OPPANOL® N100 as the high vMW PIB resin and OPPANOL® B12 as the low vMW PIB resin) with varying amounts of a surface treated fumed silica (ST Fumed Silica) wherein the surface treatment comprises HDMS and aminosilane (an amino group), an isocyanate functional crosslinking agent and a tackifier were prepared and tested relative to adhesives (3-A, 3-B and 3-C) which do not contain any crosslinking agent. The ingredients used to prepare the adhesives are set forth in Table 3, wherein the amount of each ingredient is set forth as a weight percent based on the total weight of the non-volatile ingredients in the composition. The process used for preparing these adhesives is described in “Preparation of the Adhesives for Testing.”

After preparation, the adhesives were tested as described herein and analyzed for static shear strength (70° C., 500 gram weight), adhesion to a stainless steel surface (peel strength), tight liner release, and (for certain adhesives) moisture barrier (WVTR) properties in accordance with the testing protocols described herein. The values obtained are set forth in Table 3.

This example demonstrates that the compositions with a crosslinked structure provided enhanced static shear strength relative to non-crosslinked adhesives (3-A, 3-B and 3-C), particularly when the isocyanate crosslinking agent was included in amounts ranging from about 0.1 to about 10 wt. %. Such compositions further exhibited acceptable peel strength, tight liner release, and WVTR. It was surprisingly found that including an isocyanate crosslinking agent in an amount of 12 wt. % conferred a benefit in static shear strength but not tight liner release or peel strength, while increasing the amount of this crosslinking agent to 21 wt. % did not confer any benefit in static shear strength due to relatively low adhesion, and also possessed relatively low tight liner release (which can be beneficial in certain applications) and peel strength, all relative to a non-crosslinked comparator adhesive (3-A).

TABLE 3

| | | | | | | | | | | Tight | |
|---|---|---|---|---|---|---|---|---|---|---|---|
| | | | | | | | | | | Liner | |
| | High | Low | | | | Solids | | | | Release | |
| | vMW | vMW | | | | wt. % | Static shear | | Peel | (silicone | WVTR |
| | PIB | PIB | | | | (toluene | 70° C., 500 g | | to | liners— | (g-mil/ |
| Formula | Resin | Resin | | | | as | Run 1/Run2 | | SS | AR-W4) | m²/ |
| ID | (N100) | (B12) | H1900 | RA200HS | E28 | solvent) | (mins) | | (oz/in) | (g/2 in) | day) |
| 3-A | 16.7 | 54.7 | 10.5 | 18.1 | | 17.5% | 22 | 19.2 | 64.7 | 25.7 | 7.5 |
| 3-1 | 19.4 | 52.8 | 10.2 | 17.4 | 0.1 | 18.0% | 48.5 | 55.0 | 64.2 | 23.8 | |
| 3-2 | 19.3 | 52.8 | 10.2 | 17.4 | 0.3 | 17.5% | 38.2 | 38.8 | 59.1 | 29.0 | 5.9 |
| 3-3 | 19.3 | 52.6 | 10.2 | 17.4 | 0.6 | 17.5 | 46.9 | 38.4 | 61.2 | 26.3 | |
| 3-4 | 16.6 | 54.4 | 10.4 | 17.9 | 0.7 | 17.5% | 45.7 | 58 | 68.4 | 28.3 | 10.3 |
| 3-5 | 19.2 | 52.4 | 10.1 | 17.3 | 1.1 | 17.6% | 29.6 | 28.8 | 60.4 | 28.7 | |
| 3-6 | 22.7 | 37.0 | 20.0 | 17.5 | 2.8 | 16.0% | 1801 | >10,000 | 83.3 | 25.1 | 5.0 |
| 3-7 | 21.7 | 35.3 | 19.0 | 17.5 | 6.5 | 16% | >10,000 | >10,000 | 63.1 | 13.8 | 7.1 |
| 3-8 | 20.1 | 32.7 | 17.7 | 17.5 | 12.1 | 16.0% | 102.8 | 70.8 | 2.3 | 12.6 | 10.6 |
| 3-9 | 20.2 | 23.6 | 17.7 | 17.5 | 21.0 | 16.0% | 29.4 | 38.5 | >1 | 8.5 | 10.0 |
| 3-B | 21.4 | 53.4 | 10.3 | 15 | | 17.5% | 8.8 | 7.9 | 62.9 | 26.8 | 12.9 |
| 3-10 | 21.2 | 53.0 | 10.2 | 14.9 | 0.8 | 18.0% | 36.4 | 35.1 | 70.4 | 25.4 | 10.1 |
| 3-11 | 20.8 | 51.9 | 10.0 | 14.6 | 2.7 | 18.3% | 36.7 | 25.4 | 69.9 | 25.4 | |
| 3-C | 20.1 | 50.2 | 9.6 | 20 | | 17.5% | 54.1 | 62.6 | 66 | 24.0 | 7.6 |
| 3-12 | 20.0 | 50.1 | 9.6 | 20.0 | 0.3 | 17.0% | 127 | 71.7 | 72.9 | 22.2 | |
| 3-13 | 19.9 | 50.0 | 9.6 | 20.0 | 0.6 | 17.1% | 105 | 83.2 | | 28.0 | 6.6 |
| 3-14 | 19.8 | 49.7 | 9.6 | 19.9 | 1.2 | 17.2% | 74.7 | 90.2 | 56.4 | 25.5 | |
| 3-15 | 19.6 | 49.1 | 9.4 | 19.6 | 2.3 | 17.3% | >10,000 | >10,000 | 66.8 | 28.1 | 9.0 |

H1900 = (Indopol ® H-1900): liquid polybutene polymer (tackifier)
RA200HS = (AEROSIL ® RA200HS): fumed silica surface treated with a composition comprising HMDS and aminosilane (includes an amino group)
E28 = (Desmodur ® E28): isocyanate functional crosslinking agent)

### EXAMPLE 4

Several PIB PSA compositions (which include OPPANOL®N100 as the high vMW PIB resin and OPPANOL® B12 as the low vMW PIB resin) with varying amounts of a NST fumed silica or a surface treated fumed silica (ST Fumed Silica) wherein the surface treatment does not include an unsaturated double bond or an amino group, an isocyanate functional crosslinking agent and a tackifier were prepared and tested relative to adhesives (4-A, 4-B, 4-C and 4-D) that did not contain any crosslinking agent. The ingredients used to prepare the adhesives are set forth in Table 4, wherein the amount of each ingredient is set forth as a weight percent based on the total weight of the non-volatile ingredients in the composition. The process used for preparing these adhesives is described in “Preparation of the Adhesives for Testing.”

After preparation, the adhesives were tested as described herein and analyzed for static shear strength (70° C., 500 gram weight), adhesion to a stainless steel surface (peel strength), tight liner release, and moisture barrier (WVTR) properties in accordance with the testing protocols described herein. The values obtained are set forth in Table 4.

This example demonstrates that the compositions with a crosslinked structure provided enhanced static shear strength relative to non-crosslinked adhesives (4-A, 4-B, 4-C and 4-D), particularly when the isocyanate functional crosslinking agent was included. Such compositions further exhibited acceptable peel strength, tight liner release, and, in certain compositions, acceptable WVTR. It was surprisingly found that including an isocyanate functional crosslinking agent with a ST silica which does not include a methacryloyl or an amino group, i.e., in Formula 4-3 (which is significantly less expensive relative to a ST silica that includes such groups) provided excellent static shear strength with relatively lower tight liner release and WVTR compared to a non-crosslinked adhesive. It was further, and also surprisingly, found that adhesives containing a ST silica (surface treated with a composition comprising DDS) exhibited an order of magnitude greater static shear strength relative to the same adhesive that was not crosslinked (4-C), while not affecting the peel strength, tight liner release or WVTR. In comparison, adhesives containing a ST silica (surface treated with a composition comprising OCTMO) exhibited a relatively minor increase in static shear strength, and also relatively minor changes to the peel strength, tight liner release and WVTR, relative to a non-crosslinked comparator adhesive (4-D).

In addition, it was found that including an isocyanate functional crosslinking agent in a formulation comprising about 13 wt. % of a NST silica provided some improvement in static shear strength, but did not significantly affect the peel strength, tight liner release or WVTR relative to a formulation that did not include a crosslinking agent. This result is in marked contrast to properties provided by a similar formulation that includes an isocyanate functional crosslinking agent with about 17 wt. % of a NST silica, this formulation possessing significant static shear strength (>10,000 mins) as well as desirable peel strength, tight liner release and WVTR.

TABLE 4

| | | | | | | | | | | | Tight | |
|---|---|---|---|---|---|---|---|---|---|---|---|---|
| | | | | | | | | | | | Liner | |
| | High | Low | | | | | | Solids | Static | | Release | |
| | vMW | vMW | | | | | | wt. % | shear | Peel | (silicone | WVTR |
| | PIB | PIB | | | | | | (toluene | 70° C., | to | liners— | (g-mil/ |
| Formula | Resin | Resin | | | | | | as | 500 g | SS | AR-W4) | m²/ |
| ID | (N100) | (B12) | II1900 | 200 | R974 | R805 | E28 | solvent) | (mins) | (oz/in) | (g/2 in) | day) |
| 4-A | 24.7 | 40.2 | 21.7 | 13.4 | | | | 17.7% | 34.2 | 51.8 | 42.2 | 8.14 |
| 4-1 | 23.9 | 38.9 | 21.0 | 13.0 | | | 3.2 | 18.0% | 46.7 | 63.7 | 23.0 | 7.94 |
| 4-B | 23.5 | 38.2 | 20.7 | 17.6 | | | | 17.6% | >10000 | 59.2 | 51.6 | 129.7 |
| 4-2 | 20.8 | 38.2 | 20.0 | 17.0 | | | 3.0 | 18.1% | >10000 | 58.9 | 21.8 | 74.3 |
| 4-C | 23.5 | 38.2 | 20.7 | | 17.6 | | | 17.6% | 70.0 | 51.4 | 26.9 | 8.8 |
| 4-3 | 20.8 | 38.2 | 20.0 | | 17.0 | | 3.0 | 18.1% | >10000 | 49.7 | 19.6 | 8.5 |
| 4-D | 23.5 | 38.2 | 20.7 | | | 17.6 | | 17.6% | 16.4 | 57.0 | 28.9 | 10.4 |
| 4-4 | 20.8 | 38.2 | 20.0 | | | 17.0 | 3.0 | 18.1% | 28.3 | 42.0 | 21.3 | 11.3 |

H1900 = (Indopol ® H-1900): liquid polybutene polymer (tackifier)
200 = (AEROSIL ® 200): NST (hydrophilic) fumed silica
R974 = (AEROSIL ® R974): a fumed silica surface treated with a composition comprising DDS (no methacryloyl or amino group)
R805 = (AEROSIL ® R805): a fumed silica surface treated with a composition comprising OCTMO (no methacryloyl or amino group)
E28 = (Desmodur ® E28): an isocyanate functional crosslinking agent

### EXAMPLE 5

PIB PSA compositions (which include OPPANOL® N100 as the high vMW PIB resin and OPPANOL®B12 as the low vMW PIB resin) with a ST fumed silica, acetylene black and, in one formulation, an isocyanate functional crosslinking agent, were prepared and tested. The ingredients used to prepare the adhesives are set forth in Table 5, wherein the amount of each ingredient is set forth as a weight percent based on the total weight of the non-volatile ingredients in the composition. The process used for preparing these adhesives is described in “Preparation of the Adhesives for Testing.”

After preparation, the adhesives were tested as described herein and analyzed for static shear strength (70° C., 500 gram weight), adhesion to a stainless steel surface (peel strength), tight liner release, moisture barrier (WVTR) and resistivity properties in accordance with the testing protocols described herein. The values obtained are set forth in Table 5.

This example demonstrates that the use of the crosslinking agent provided an enhanced increase in static shear strength, while not adversely affecting the peel strength, tight liner release, WVTR and resistivity.

TABLE 5

| | | | | | | | | | Tight | | | |
|---|---|---|---|---|---|---|---|---|---|---|---|---|
| | | | | | | | | | Liner | | | |
| | High | Low | | | | Solids | Static | | Release | | | |
| | vMW | vMW | | | | wt. % | shear | Peel | (silicone | WVTR | | |
| | PIB | PIB | | | | (toluene | 70° C., | to | liners— | (g-mil/ | Resistivity | Resistivity |
| Formula | Resin | Resin | | | | as | 500 g | SS | AR-W4) | m²/ | (5 μm | (1 mil |
| ID | (N100) | (B12) | AB | R974 | E28 | solvent) | (mins) | (oz/in) | (g/2 in) | day) | 11#, ohm) | 11#, ohm) |
| 5-A | 19.5 | 58.5 | 11.0 | 11.0 | | 18% | 127.3 | 22.5 | 14.1 | 8.1 | 2.6 | 189.1 |
| 5-1 | 19.0 | 57.0 | 10.7 | 10.7 | 2.7 | 18.4% | >10,000 | 14.1 | 19.3 | 7.1 | 6.6 | 237.0 |

AB = Acetylene Black
R974 = (AEROSIL ® R974): a fumed silica surface treated with a composition comprising DDS (no methacryloyl or amino group)
E28 = (Desmodur ® E28): an isocyanate functional crosslinking agent

### EXAMPLE 6

PIB PSA compositions (which include OPPANOL® N100 as the high vMW PIB resin and OPPANOL® B12 as the low vMW PIB resin) with a NST fumed Alumina, and, in one formulation, an isocyanate functional crosslinking agent, were prepared and tested. The ingredients used to prepare the adhesives are set forth in Table 6, wherein the amount of each ingredient is set forth as a weight percent based on the total weight of the non-volatile ingredients in the composition. The process used for preparing these adhesives is described in “Preparation of the Adhesives for Testing.”

After preparation, the adhesives were tested as described herein and analyzed for static shear strength (70° C., 500 gram weight), adhesion to a stainless steel surface (peel strength), tight liner release, in accordance with the testing protocols described herein. The values obtained are set forth in Table 6.

TABLE 6

| | | | | | | | | | Tight Liner |
|---|---|---|---|---|---|---|---|---|---|
| | High | Low | | | | Solids | Static | | Release |
| | vMW | vMW | | | | wt. % | shear | Peel | (silicone |
| | PIB | PIB | | | | (toluene | 70° C., | to | liners - |
| Formula | Resin | Resin | | | | as | 500 g | SS | AR-W4) |
| ID | (N100) | (B12) | H1900 | Alu C | E28 | solvent) | (mins) | (oz/in) | (g/2 in) |
| 6-A | 22.3 | 36.2 | 19.6 | 22.0 | | 16% | 29.5 | 68.2 | 62.1 |
| 6-1 | 21.6 | 35.2 | 19.0 | 21.4 | 2.9 | 16% | 41.8 | 63.9 | 27.6 |

Alu C = NST fumed alumina
H1900 = (Indopol ® H-1900): liquid polybutene polymer (tackifier)
E28 = (Desmodur ® E28): an isocyanate functional crosslinking agent

This example demonstrates that the inclusion of a crosslinking agent provided enhanced static shear strength while not adversely affecting peel strength or tight liner release relative to a composition that does not include the crosslinking agent.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

References to weight percents herein should be understood to describe an amount of a component or ingredient based on the non-volatile components in the filled PIB PSA composition, unless contradicted by express language or context.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1.-44. (canceled)

45. A composition comprising:
(a) about 10 to about 40 of a PIB resin having a vMW ranging from 300,000 to about 3,000,000 g/mol;
(b) about 20 to about 70 wt. % of a PIB resin having a vMW ranging from about 35,000 to about 100,000 g/mol;
(c) about 5 to about 30 wt. % of a surface-treated filler, wherein the surface treatment comprises a silane, a silazane or a combination thereof, and wherein the silane and silazane each include an unsaturated double bond,
(d) about 0.1 to about 15 wt. % of a SiH functional crosslinking agent, and
(e) about 0.001 to about 5 wt. % of a crosslinking catalyst,
wherein the weight percents are based on the non-volatile ingredients in the composition.

46. The composition of claim 45 further comprising about 0.1 to about 20 wt. % of a functional resin comprising a vinyl functional group.

47. The composition of claim 45 further comprising about 0.05 to about 5 wt. % of a catalyst inhibitor.

48. The composition of claim 45 further compositing about 1 to about 30 wt. % of a tackifier.

49. The composition of claim 45, wherein the SiH functional crosslinking agent is a siloxane comprising at least two SiH functional groups.

50. The composition according to claim 45 further comprising acetylene black.

51. A pressure sensitive adhesive provided by the composition of claim 45.

52. A composition comprising:
(a) about 10 to about 40 wt. % of a PIB resin having a vMW ranging from 300,000 to about 3,000,000 g/mol;
(b) about 20 to about 70 wt. % of a PIB resin having a vMW ranging from about 35,000 to about 100,000 g/mol;
(c) about 5 to about 30 wt. % of a surface-treated filler, wherein the surface treatment comprises a silane, a silazane or a combination thereof, and wherein the silane and silazane each include an unsaturated double bond, and (d) about 0.1 to about 15 wt. % of a SH functional crosslinking agent,
wherein the weight percents are based on the non-volatile ingredients in the composition.

53. The composition of claim 52 further comprising about 0.1 to about 20 wt. % of a functional resin.

54. The composition of claim 52 further comprising about 0.01 to about 5 wt. % of a radical initiator

55. The composition of claim 52 further comprising about 1 to about 30 wt. % of a tackifier.

56. The composition of claim 52, wherein the SH functional crosslinking agent is a thiol comprising at least two SH functional groups.

57. The composition according to claim 56, wherein the SH functional crosslinking agent is PEMP and/or TMMP.

58. The composition according to claim 52 further comprising acetylene black.

59. A pressure sensitive adhesive provided by the composition of claim 52.

60. A composition comprising:
(a) about 10 to about 40 wt. % of a PIB resin having a vMW ranging from 300,000 to about 3,000,000 g/mol;
(b) about 20 to about 70 wt. % of a PIB resin having a vMW ranging from about 35,000 to about 100,000 g/mol;
(c) about 5 to about 30 wt. % of a surface-treated filler, wherein the surface treatment comprises a silane, a silazane or a combination thereof, and (d) about 0.1 to about 20 wt. % of an isocyanate functional crosslinking agent,
wherein the weight percentages are based on the non-volatile ingredients in the composition.

61. The composition according to claim 60, wherein the surface-treated filler does not include a (meth) acryloyl or an amino group.

62. The composition according to claim 60, wherein the surface-treated filler comprises an amino group.

63. The composition according to claim 60 further comprising about 0.1 to about 20 wt. % of a functional polyol, polyamine or polythiol resin.

64. The composition according to claim 60 further comprising about 0.01 to about 5 wt. % of a catalyst.

65. The composition according to claim 60 further comprising about 1 to about 30 wt. % of a tackifier.

66. The composition according to claim 60 further comprising acetylene black.

67. A pressure sensitive adhesive provided by the composition of claim 60.

68. A composition comprising:
(a) about 10 to about 40 wt. % of a PIB resin having a vMW ranging from 300,000 to about 3,000,000 g/mol;
(b) about 20 to about 70 wt. % of a PIB resin having a vMW ranging from about 35,000 to about 100,000 g/mol;
(c) about 5 to about 30 wt. % of a non-surface-treated filler, and
(d) about 0.1 to about 20 wt. % of an isocyanate crosslinking agent,
wherein the weight percentages are based on the non-volatile ingredients in the composition.

69. The composition according to claim 68, wherein the non-surface-treated filler is a fumed silica.

70. The composition according to claim 68, wherein the non-surface-treated filler is a fumed alumina.

71. The composition according to claim 68 further comprising about 0.1 to about 20 wt. % of a functional polyol, polyamine or polythiol resin.

72. The composition according to claim 68 further comprising about 0.01 to about 5 wt. % of a catalyst.

73. The composition according to claim 68 further comprising about 1 to about 30 wt. % of a tackifier.

74. The composition according to claim 68 further comprising acetylene black.

75. A pressure sensitive adhesive provided by the composition of claim 68.
